(19) United States
(12) Patent Application Publication
(10) Pub. No.: US 2004/0193609 A1
(43) Pub. Date: Sep. 30, 2004

(54) Master content directory service server for providing a consolidated network-wide content directory

(75) Inventors: Dan M. Phan, San Jose, CA (US); Edward Eytchison, Milpitas, CA (US)

Correspondence Address: Jonathan O. Owens, HAVERSTOCK & OWENS LLP, 162 North Wolfe Road, Sunnyvale, CA, 94086, US

(73) Assignees: Sony Corporation; Sony Electronics Inc.

(21) Appl. No.: 10/402,305

(22) Filed: Mar. 26, 2003

(51) Int. Cl. G06F 17/30

(52) U.S. Cl. 707/10

(57) ABSTRACT

A master content directory service (CDS) provides a consolidated CDS which includes content listings representing all of the content within the network. A component of the master CDS functioning as a control point application periodically queries each CDS within the network in order to obtain the content listings for processing and inclusion within the master CDS. The component of the master CDS functioning as a control point application preferably also subscribes to each CDS within the network to receive notification of changes in content. Control point applications within the network access the consolidated master CDS to search content listings from all devices within the network. Preferably, the content itself is stored on the original device. When a control point application, accessing the master CDS, selects content for rendering, a communication is sent to the source device for the selected content. The selected content is then transmitted from the source device to the requesting device.

### FIELD OF THE INVENTION

The present invention relates to the field of transmitting information between devices within a network structure. More particularly, the present invention relates to the field of providing a consolidated content directory within a network structure.

### BACKGROUND OF THE INVENTION

The Universal Plug and Play (UPnP) standard is designed to enable simple and robust connectivity among stand-alone devices and personal computers (PCs) from many different vendors. With UPnP, a device can dynamically join a network, obtain an Internet Protocol (IP) address, convey its capabilities, and learn about the presence and capabilities of other devices. Devices can subsequently communicate with each other directly, thereby enabling discovery and control of devices. UPnP uses standard Transmission Control Protocol/Internet Protocol (TCP/IP) and Internet protocols which facilitates interoperability with existing networks.

The basic building blocks of a UPnP network are devices, services and control points. A UPnP device is a container of services and nested devices. A UPnP device can be, but does not have to be, a physical device. Different categories of UPnP devices are associated with different sets of services and embedded devices. For instance, services within a video cassette recorder (VCR) are different than those within a printer. The set of services provided by a particular device, as well as a list of properties associated with the particular device, are captured in a device description document that the device must host. Preferably, this device description document is written in Extensible Markup Language (XML).

A service exposes actions and models its state with state variables. For instance, as an example, a clock service can be modeled as having a state variable, current_time, which defines the state of the clock, and two actions, set_time and get_time, which enables control of the service. Similar to the device description, this information is part of a service description document preferably written in XML. The UPnP Forum defines UPnP Device and Service Descriptions according to a common architecture. A pointer, such as a Uniform Resource Locator (URL), to each appropriate service description document is included within a device description document. Devices may include multiple services.

A service in a UPnP device includes a state table, a control server and an event server. The state table models the state of the service through state variables and updates them when the state changes. The control server receives action requests, such as set_time, executes the action requests, updates the state table and returns responses. The event server publishes events to interested subscribers anytime the state of the service changes. For instance, a fire alarm service sends an event to interested subscribers when its state changes to “ringing.”

A control point in a UPnP network is a controller capable of discovering and controlling other devices. After discovery of a network device, a control point can retrieve the device description and get a list of associated services, retrieve service descriptions for available services and invoke actions to control the service. The control point can also subscribe to the service's event source such that anytime the state of the service changes, the event server sends an event to the control point.

UPnP uses open, standard protocols such as TCP/IP, HyperText Transport Protocol (HTTP) and XML. Using these standardized protocols aids in ensuring interoperability between vendor implementations. Other technologies can also be used to network devices together. Such technologies include networking technologies such as Home Audio Video Interoperability (HAVi), Consumer Electronic Bus (CEBus), LonWorks, European Installation Bus (EIB), or X10. These too can participate in the UPnP network through a UPnP bridge or proxy.

A conventional protocol stack used to implement UPnP is illustrated in FIG. 1. The protocol stack includes a TCP/IP networking protocol stack 10, an HTTP layer 18, an HTTPU (HTTP unicast over User Datagram Protocol (UDP)) layer 20, an HTTPMU (HTTP multicast over UDP) layer 22, an SSDP (Simple Service Discovery Protocol) layer 24, a GENA (General Event Notification Architecture) layer 26, a SOAP (Simple Object Access Protocol) layer 28, a UPnP Device Architecture Defined layer 30, a UPnP Forum Working Committee Defined layer 32 and a UPnP Vendor Defined layer 34. The TCP/IP protocol stack 10 includes an IP layer 16, a TCP layer 14 and a UDP layer 12. The TCP/IP networking protocol stack 10 serves as the base on which the rest of the UPnP protocols are built. By using the standard, prevalent TCP/IP protocol suite, UPnP leverages the protocol's ability to span different physical media and ensures multiple vendor interoperability. UPnP devices can use many of the protocols in the TCP/IP protocol suite including TCP, UDP, IGMP (Internet Group Multicast Protocol), ARP (Address Resolution Protocol) and IP, as well as TCP/IP services such as DHCP (Dynamic Host Configuration Protocol) and DNS (Domain Name System). TCP/IP provides the base protocol stack for network connectivity between UPnP devices.

All aspects of UPnP build on top of HTTP or its variants. HTTPU and HTTPMU are variants of HTTP defined to deliver messages on top of UDP/IP instead of TCP/IP. HTTPU and HTTPMU are protocols used by SSDP, which is described below. The basic message format used by HTTPU and HTTPMU adheres with that of HTTP and is required both for multicast communication and when message delivery does not require the overhead associated with reliability.

SSDP provides a mechanism for discovering network devices on the network. SSDP is built on HTTPU and HTTPMU and defines methods both for a control point to locate resources on the network, and for devices to announce their availability on the network. By defining the use of both search requests and presence announcements, SSDP eliminates the overhead that would be necessary if only one of these mechanisms is used. As a result, every control point on the network has complete information on network state while keeping network traffic low.

Both control points and devices use SSDP. A UPnP control point, upon booting up, can send a multicast SSDP search request over HTTPMU to discover devices that are available on the network. The control point can refine the search to find only devices of a particular type, such as a VCR, particular services, such as devices with clock services, or even a particular device. UPnP devices listen to the multicast port. Upon receiving a search request, the device examines the search criteria to determine if they match. If a match is found, a unicast SSDP over HTTPU response is sent to the control point. Similarly, a device, upon being connected to the network, sends out multiple SSDP presence announcements advertising itself.

Both presence announcements and unicast device response messages include a pointer, such as a URL, to the location of the device description document, which has information on the set of properties and services supported by the device.

The process involved in UPnP networking includes addressing, discovery, description, control, eventing and presentation. UPnP provides support for communication between control points and devices. The network media, the TCP/IP protocol suite and HTTP provide basic network connectivity and addressing. On top of these open, standard, Internet based protocols, UPnP defines a set of HTTP servers to handle discovery, description, control, events and presentation.

Each device includes a DHCP client that searches for a DHCP server when the device is first connected to the network. If a DHCP server is available, the device uses the IP address assigned to it. If no DHCP server is available, the device uses Auto IP to get an address.

Once devices are attached to the network and addressed appropriately, discovery can take place. Discovery is handled by the SSDP, as discussed above. When a UPnP device is added to the network, SSDP enables the device to advertise its services to control points on the network. When a control point is added to the network, SSDP enables the control point to search for UPnP devices on the network. The fundamental exchange in both cases is a discovery message containing a few, essential specifics about the device or one of its services, for example its type, identifier, and a pointer to its XML device description document.

The next step in UPnP networking is description. After a control point discovers a device, the control point still knows very little about the device. For the control point to learn more about the device and its capabilities, or to interact with the device, the control point must retrieve the device's description from the URL provided by the device in the discovery message.

Devices can include other logical devices and services. The UPnP description for a device is preferably expressed in XML and includes vendor-specific, manufacturer information including the model name and number, serial number, manufacturer name, URLs to vendor-specific Web sites, and so forth. The description also includes a list of any embedded devices or services, as well as URLs for control, eventing and presentation.

After the control point has retrieved a description of the device, the control point has the essentials for device control. To learn more about the service and device, the control point must retrieve a detailed UPnP description for each service. The description for a service is also preferably expressed in XML and includes a list of the commands, or actions, the service responds to, and parameters or arguments, for each action. The description for a service also includes a list of variables. These variables model the state of the service at run time, and are described in terms of their data type, range, and event characteristics.

To control a device, the control point sends an action request to a device's service. To do this, the control point sends a suitable control message to the control URL for the service that is provided in the device description. Control messages are expressed in XML using simple object access protocol (SOAP). In response to the control message, the service returns action specific values or fault codes.

UPnP architecture defines the general interaction between UPnP control points and UPnP network devices containing audio/video (AV) media. The UPnP architecture is independent of any particular device type, content format, and transfer protocol. The UPnP architecture enables a UPnP control point to discover UPnP network devices within a network, and to enumerate the content available on each discovered UPnP network device. Each UPnP network device uses a UPnP Content Directory Service to compile detailed information about each content item on the UPnP network device. Each content item that is referenced by the Content Directory Service includes various information about the content item including the transfer protocol(s) and file format(s) that the UPnP network device storing the content item can use to transfer the content item to another UPnP network device.

The Content Directory Service provides a lookup and storage service that allows control points to locate individual objects that the device is capable of providing. For example, the Content Directory Service is used to enumerate a list of songs stored on an MP3 player, a list of still-images comprising various slide-shows, a list of movies stored in a DVD-Jukebox, a list of television shows currently being broadcast and the like. Nearly any type of content can be enumerated using the Content Directory Service.

The Content Directory Service defines a class system to represent the different types of objects that are managed by the Content Directory Service. The class hierarchy of the Content Directory Service is used to type all objects that can be retrieved from the Content Directory Service. The base class, from which all other classes are derived, is referred to as an object. A class is used to assign a type to an object, and identifies the minimum required and optional set of properties that must be present on that object. Classes are organized in a hierarchy with certain classes being derived from others as in a typical object oriented system. The object base class is at the root of the class hierarchy. An item is a first-level class if derived directly from an object. An item most often represents a single piece of AV data, such as a CD track, a movie or an audio file. Items may be playable, meaning they have information that can be played on a rendering device. A container is a first-level class derived directly from an object. A container represents a collection of objects. Containers can represent the physical organization of objects or logical collections. Logical collections can have formal definitions of their contents or they can be arbitrary collections. Containers can be either homogeneous, containing objects that are all of the same class, or heterogeneous, containing objects of mixed class. Containers can also contain other containers.

In general, a UPnP control point discovers UPnP network devices within a network. This discovery can take place over both wired and wireless networks. The control point interacts with the discovered devices to locate desired content. Once the content is identified, the control point identifies a common transfer protocol and data format that can be used to transfer the content from the UPnP network device on which the content is located and a UPnP network device to which the content is to be rendered. After these transfer parameters are established, the control point controls the flow of content. The actual transfer of the content is performed directly by the two UPnP network devices, the media server and the renderer. The content transfer happens independently from the control point and does not involve the UPnP protocol. The control point uses UPnP to initialize the transfer of the content, but the transfer is performed using an appropriate transfer protocol other than UPnP, including but not limited to HTTP, RTP/RTSP and IEEE 1394.

The Content Directory Service is resident on each respective device having content and represents the content stored on the device. When searching for content within a UPnP network, an application must search each device's Content Directory Service until the desired content is located. Once the desired content is located, that content can then be sent from the appropriate source device to the appropriate receiving device.

### SUMMARY OF THE INVENTION

A master content directory service (CDS) provides a consolidated CDS which includes content listings representing all of the content within the network. A component of the master CDS functioning as a control point application periodically queries each CDS within the network in order to obtain the content listings for processing and inclusion within the master CDS. The component of the master CDS functioning as a control point application preferably also subscribes to each CDS within the network to receive notification of changes in content. Control point applications within the network access the consolidated master CDS to search content listings from all devices within the network. Preferably, the content itself is stored on the original device. When a control point application, accessing the master CDS, selects content for rendering, a communication is sent to the source device for the selected content. The selected content is then transmitted from the source device to the requesting device.

In a first aspect of the present invention, a method of providing a master content directory within a network of devices comprises querying devices within the network having a content directory service to obtain content listings and consolidating the content listings from the devices within the network into the master content directory. The method further comprises providing access to the master content directory to the devices within the network. The method further comprises receiving a selection of content listed in the master content directory from a requesting device and transmitting selected content from a source device of the selected content to the requesting device. Preferably, querying devices is performed periodically. The method further comprises subscribing to receive notification of changes to the content listings from the device. The method further comprises updating the master content directory in response to a notification of change. Consolidating preferably includes detecting duplicate entries and selecting a single entry of a content listing to include within the master content directory. The method further comprises including metadata information corresponding to the content listings within the master content directory. The metadata information is obtained from a selective one of a source device of the content listing and remote sources of the metadata information. The method alternatively comprises consolidating the content listings from the devices within the network at multiple devices in a hierarchical fashion, wherein the master content directory is the only consolidated listing of content listings for all devices within the network. Preferably, the network of devices includes devices that are UPnP enabled.

In a second aspect of the present invention, an apparatus for providing a master content directory within a network of devices comprises an interface to the network of devices, a querying application coupled to the interface to query devices within the network having a content directory service to obtain content listings and a consolidated master content directory including the content listings from the devices within the network, the consolidated master content directory receiving the content listings obtained by the querying application. The interface provides access to the consolidated master content directory to the devices within the network. If a selection of content listed in the consolidated master content directory is received from a requesting device, then a notification is sent from the interface to a source device of the selected content. The querying application preferably queries the devices within the network having a content directory service periodically. The querying application preferably subscribes to receive notification of changes to the content listings from the devices within the network having a content directory service. Preferably, the consolidated master content directory selects a single entry of a content listing to include if multiple content listings for the same content are included in the content listings obtained by the querying application. Metadata information is included within the consolidated master content directory. The metadata information is obtained from a selective one of a source device of the content listing and remote sources of the metadata information. Preferably, network of devices includes devices that are UPnP enabled.

In a further aspect of the present invention, an apparatus for providing a master content directory within a network of devices comprises means for interfacing to the network of devices, means for querying coupled to the means for interfacing for querying devices within the network having a content directory service to obtain content listings and means for providing a consolidated master content directory coupled to the means for querying for providing content listings from the devices within the network, the consolidated master content directory receiving the content listings obtained by the querying application. The means for interfacing provides access to the consolidated master content directory to the devices within the network. If a selection of content listed in the consolidated master content directory is received from a requesting device, then a notification is sent from the interface to a source device of the selected content. The means for querying preferably queries the devices within the network having a content directory service periodically. The means for querying preferably subscribes to receive notification of changes to the content listings from the devices within the network having a content directory service. The means for providing preferably selects a single entry of a content listing to include if multiple content listings for the same content are included in the content listings obtained by the querying application. The means for providing also provides metadata information corresponding to the content listings within the consolidated master content directory. The metadata information is obtained from a selective one of a source device of the content listing and remote sources of the metadata information. Preferably, the network of devices includes devices that are UPnP enabled.

In still a further aspect of the present invention, a host device within a network of devices, the host device comprises a client application programming interface to communicate with devices within the network of devices, a querying application coupled to the client application programming interface to query devices within the network having a content directory service to obtain content listings and a consolidated master content directory including the content listings from the devices within the network, the consolidated master content directory receiving the content listings obtained by the querying application. The host device further comprises a server application programming interface coupled to provide access to the consolidated master content directory to the devices within the network. If a selection of content listed in the consolidated master content directory is received from a requesting device, then a notification is sent from the server application programming interface to a source device of the selected content. The querying application preferably queries the devices within the network having a content directory service periodically. The querying application preferably subscribes to receive notification of changes to the content listings from the devices within the network having a content directory service. The consolidated master content directory preferably selects a single entry of a content listing to include if multiple content listings for the same content are included in the content listings obtained by the querying application. Metadata information is included within the consolidated master content directory. The metadata information is obtained from a selective one of a source device of the content listing and remote sources of the metadata information. Preferably, the network of devices includes devices that are UPnP enabled.

In still yet another aspect of the present invention, a network of devices comprises a plurality of content servers each having a content directory service, one or more control point applications and a host device including a client application programming interface to communicate with the plurality of content servers, a querying application coupled to the client application programming interface to query the plurality of content servers to obtain content listings from the content directory services, a consolidated master content directory including the content listings from the content servers, the consolidated master content directory receiving the content listings obtained by the querying application and a server application programming interface coupled to provide access to the consolidated master content directory to the control point applications. If a selection of content listed in the consolidated master content directory is received from a requesting device, then a notification is sent from the server application programming interface to a source device of the selected content. The querying application preferably queries the content servers periodically. The querying application preferably subscribes to receive notification of changes to the content listings from the content servers. The consolidated master content directory preferably selects a single entry of a content listing to include if multiple content listings for the same content are included in the content listings obtained by the querying application. Metadata information is included within the consolidated master content directory. The metadata information is obtained from a selective one of a source content server and remote sources of the metadata information. Preferably, the network of devices includes devices that are UPnP enabled.

### BRIEF DESCRIPTION OF THE DRAWINGS

FIG. 1 illustrates a conventional protocol stack used to implement UPnP.

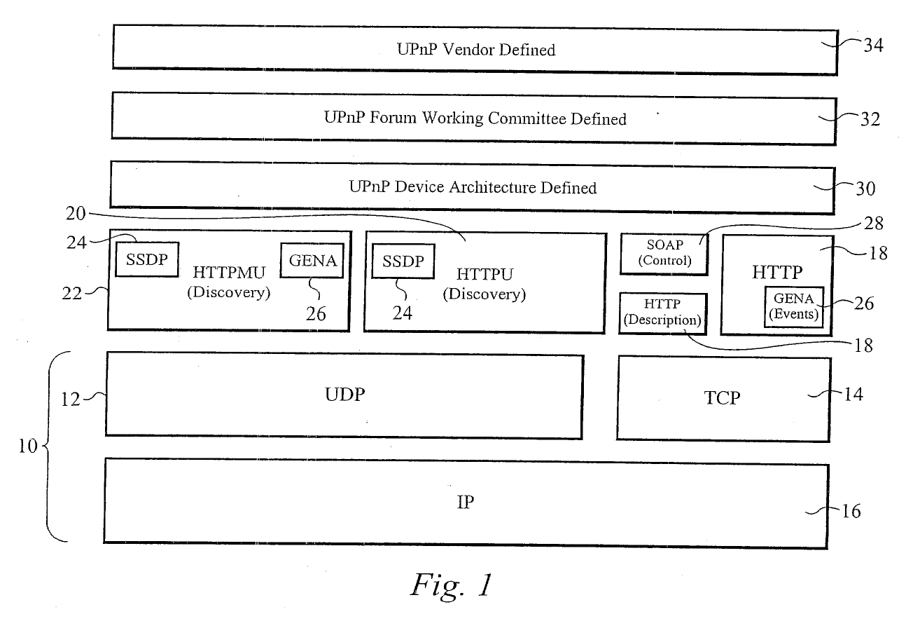

FIG. 2 illustrates an exemplary network of devices including a computer system 50 with display 52, a CD jukebox 60, a DVD player 58, a television 54 and a settop box 56, coupled together by input/output (I/O) busses 64, 66, 68 and 70.

FIG. 3 illustrates the exemplary network of devices and subsystems of FIG. 2, with the associated CDS of each appropriate device.

FIG. 4 illustrates a block diagram of the internal components of an exemplary computer system.

FIG. 5 illustrates an exemplary UPnP network of devices.

FIG. 6 illustrates a flowchart of the preferred method of generating, providing and maintaining the consolidated master CDS of the present invention.

FIG. 7 illustrates an examplary hierarchical master CDS system of an alternate embodiment of the present invention, within an exemplary network.

### DETAILED DESCRIPTION OF THE PREFERRED EMBODIMENT

The master content directory service (CDS) of the present invention provides a consolidated CDS which includes content listings compiled from each CDS within the network. These content listings within the master CDS represent all of the content listings within each CDS within the network. The master CDS is preferably implemented on a host device and managed by that device's client API. This host device has features of a control point application, which obtains the content listings and maintains the master CDS. The host device also has features of a server application which allows other control point applications throughout the network to access the content listings within the master CDS.

The control point application of the host device, through the client API, periodically queries each CDS within the network in order to obtain the content listings from each CDS. These content listings obtained by the control point application, are then processed and included within the master CDS. New content listings are added to the master CDS and removed content listings are deleted from the master CDS after the content listings are added to or removed from the respective CDS within the network. The host device's control point application also preferably subscribes to each CDS within the network. With the subscription, when content is added to or removed from a respective CDS within the network, the device implementing that CDS sends notification to the control point of the host device implementing the master CDS. The control point application will then either add or remove a content listing within the master CDS, as appropriate, based on this notification.

Control point applications within the network access the consolidated master CDS to search and obtain content listings from all devices within the network. Preferably, the content itself is stored on the original device and not on the device implementing the master CDS. Thus, the master CDS provides an index content listings representing the content available within the network. Within the master CDS, information is maintained and associated with each content listing regarding the source device for the content listing. Preferably, the master CDS is a data store of pointers to the content, represented by the content listings, throughout the network. When a control point application, accessing the master CDS, selects content for rendering at the device implementing the requesting control point application, a communication is sent to the source device for the selected content, notifying that device that the content has been requested. The transfer parameters are then established for the transmission of the content. The selected content is then transmitted or streamed from the source device to the requesting device in response to this notification.

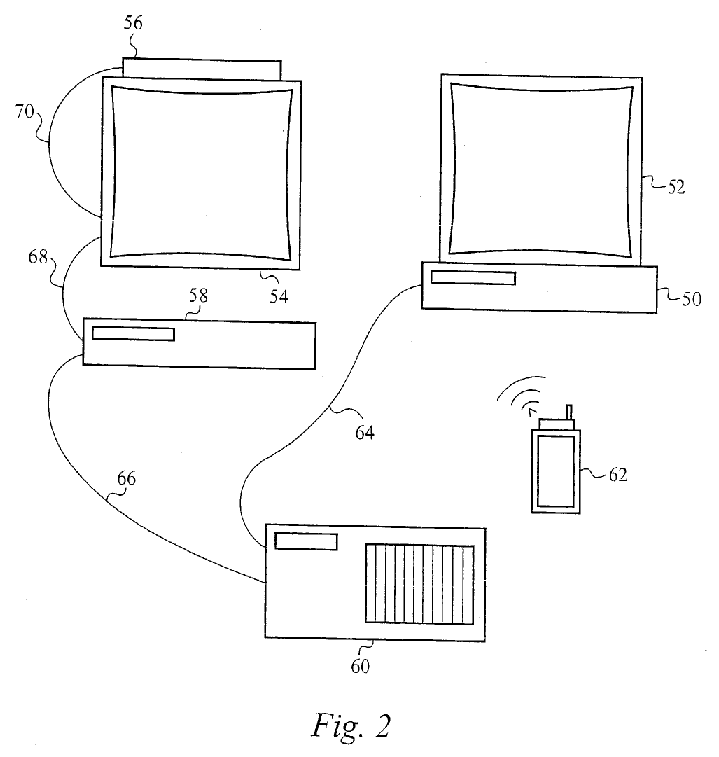

FIG. 2 illustrates an exemplary network of devices including a computer system 50 with an associated display 52, a CD jukebox 60, a DVD player 58, a television 54 and a settop box 56, coupled together by input/output (I/O) busses 64, 66, 68 and 70. The exemplary network of FIG. 2 also includes a personal digital assistant (PDA) device 62 wirelessly coupled to the network. The I/O bus 64 couples the computer system 50 to the CD jukebox 60. The I/O bus 66 couples the CD jukebox 60 to the DVD player 58. The I/O bus 68 couples the DVD player 58 to the television 54. The I/O bus 70 couples the television 54 to the settop box 56.

In the preferred embodiment of the present invention, each of the subsystems within the exemplary network of FIG. 2, including the computer system 50, the CD jukebox 60, the DVD player 58, the television 54, the settop box 56 and the PDA device 62 are Universal Plug and Play (UPnP) enabled. Within the exemplary network of FIG. 2, the computer system 50 is a media server and implements the master CDS of the preferred embodiment of the present invention. Alternatively, the master CDS of the present invention is implemented by any appropriate device or subsystem within the network.

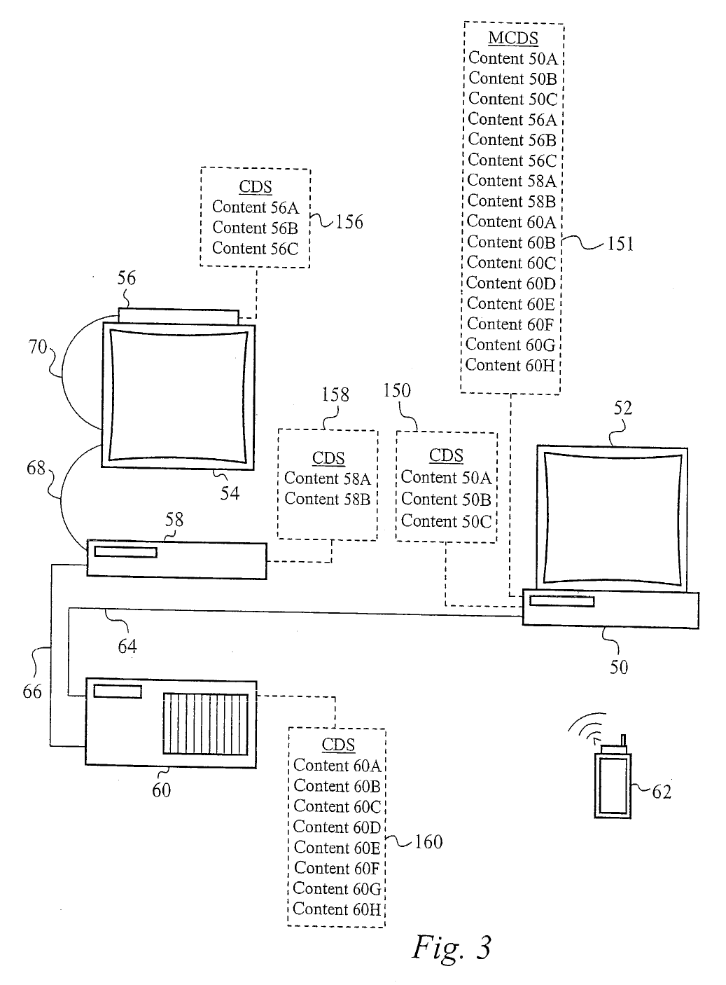

FIG. 3 illustrates the exemplary network of devices and subsystems of FIG. 2, with the associated CDS of each appropriate device. The settop box 56 includes an associated CDS 156 which lists the content available on the settop box 56. The DVD player 58 includes an associated CDS 158 which lists the content available on the DVD player 58. The CD jukebox 60 includes an associated CDS 160 which lists the content available on the CD jukebox 60. The computer system 50 also includes an associated CDS 150 which lists the content available on the computer system 50. The computer system 50 further includes the master CDS (MCDS) 151 of the present invention which preferably consolidates and lists the content from every CDS 150, 156, 158 and 160, within the network, as will be discussed below in more detail. The master CDS 151 preferably is accessible from any device within the network, including the PDA 62.

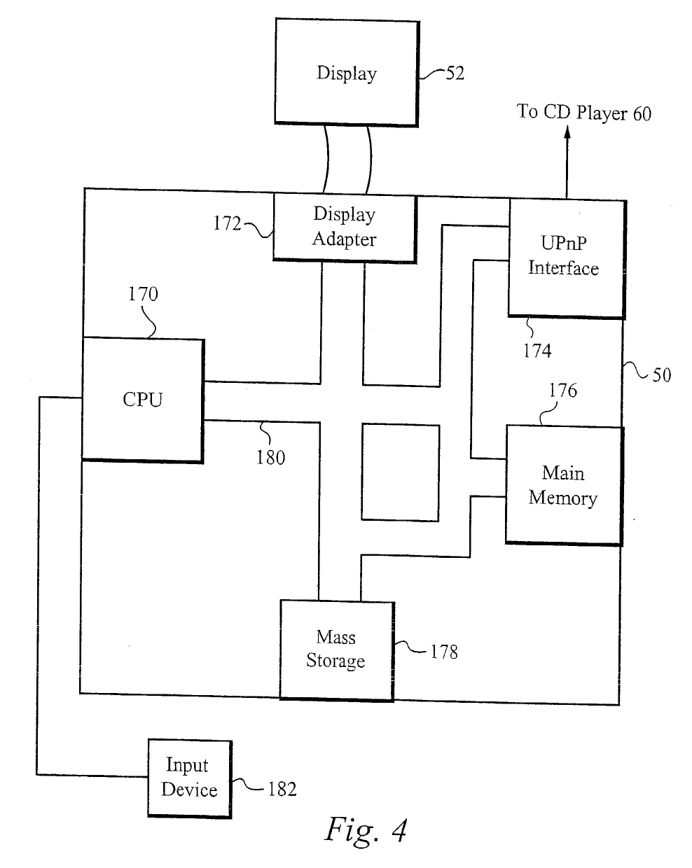

A block diagram of the internal components of the computer system 50 is illustrated in FIG. 4. While the master CDS 151 can be provided and maintained on any appropriately configured device, an exemplary computer system 50 for providing and maintaining the master CDS 151 of the present invention, is illustrated in FIG. 4. The exemplary computer system 50 includes a CPU 170, a display adapter 172, a UPnP interface circuit 174, a main memory 176 and a mass storage device 178, all coupled together by a conventional bidirectional system bus 180. The UPnP interface 174 preferably operates according to the UPnP protocol and couples the computer system 50 to the network of devices through an included network adapter. The mass storage device 178 may include both fixed and removable media using any one or more of magnetic, optical or magneto-optical storage technology or any other available mass storage technology. Content within the computer system 50 is stored within the mass storage device 178. The system bus 180 contains an address bus for addressing any portion of the memory 176 and 178. The system bus 180 also includes a data bus for transferring data between and among the CPU 170, the main memory 176, the display adapter 172, the mass storage device 178 and the UPnP interface 174.

The computer system 50 is also coupled to a number of peripheral input and output devices including the input device 182 and the associated display 52. The input device 182 may be any appropriate input device including keyboard, mouse, touch screen or stylus.

The display adapter 172 interfaces between the components within the computer system 50 and the display 52. The display adapter 172 converts data received from the components within the computer system 50 into signals which are used by the display 52 to generate images for display.

The master CDS of the present invention provides a network wide content-centric media CDS to UPnP control point applications. As discussed above, a UPnP-conforming software application or device which allows the users to control other UPnP-conforming devices and servers is known as a UPnP control point. The UPnP control point uses the UPnP Client Application Programming Interface (API) to interoperate with other UPnP-conforming devices and servers. Currently, UPnP control point applications can obtain a list of media items stored in a content directory of a CDS. This is known as a device-centric view. To present a list of media items consolidated from several CDSs to the user, the control point application must retrieve the list of media items from each CDS and then display the list or lists of content to the user after processing the retrieved list. This is known as a content-centric view.

In an alternate embodiment of the present invention, another layer is added to each control point API, to automatically and periodically browse and search each CDS server individually, process the retrieved lists and then present the consolidated resulting list within the master CDS to the higher level application. In this alternate embodiment, this task is performed at each control point, such that each control point will have a master CDS including a consolidated listing of the content available within the network. This embodiment is not preferred, because it requires multiple devices (each control point) to query each CDS server within the network and provide and maintain the master CDS of the present invention. This results in more network traffic and congestion, which can lead to reduced performance of the network.

In the preferred embodiment of the present invention, the master CDS is consolidated at a single device within the network. This allows the control point API of the other devices within the network to remain lightweight and reduces the necessary number of communications between the devices within the network in order to provide and maintain the master CDS. The device hosting the consolidated master CDS of the preferred embodiment, has attributes of both a control point and a server. From the perspective of the control point applications using the existing UPnP client API, the consolidated master CDS is simply a CDS. All of the existing APIs are fully compatible with the consolidated master CDS. From the perspective of CDS servers, the consolidated master CDS is a control point application, which periodically queries every discovered CDS within the network listing to obtain the content listing from each CDS.

The master CDS of the preferred embodiment of the present invention employs both a pull model and a push model to obtain content listings from each CDS within the network. The pull model is employed when the control point application, implementing the master CDS, periodically queries each discovered CDS within the network and obtains the content listings to be included within the master CDS. The control point application, implementing the master CDS, also employs a push model, by subscribing to each discovered CDS to obtain notification from the device hosting the CDS when the content listing within the CDS is changed.

The consolidated master CDS of the preferred embodiment of the present invention reduces network traffic and congestion within the network. In the alternate embodiment described above, in which the master CDS is provided and maintained on each control point device, then every control point device must communicate with every CDS within the network. This presents a scalability issue. If there are N applications and M CDS servers, then in this alternate embodiment, N×M sets of messages will be required in order to provide the master CDS on each control point device. However, providing a consolidated master CDS on a single device within the network, requires only N+M sets of messages. As N and M grow larger, the difference in network traffic between the distributed master CDS of the alternate embodiment and the consolidated master CDS of the preferred embodiment, will increase considerably.

Further, in the alternate embodiment, each control point device hosting a master CDS, must have the appropriate capabilities in order to perform the necessary queries and provide the master CDS. For some devices with limited resources, this requirement could be very taxing. This issue of limited system requirements is also a concern when the lists from each CDS are gathered and must be processed to be included within the master CDS. Using the consolidated master CDS of the preferred embodiment, the master CDS can preferably be hosted on a more powerful device within the network. The consolidated master CDS of the preferred embodiment of the present invention also reduces the necessary communications from each CDS within the network and ensures that each control point application will be presented with a consistent master CDS, having the same organization and categorization.

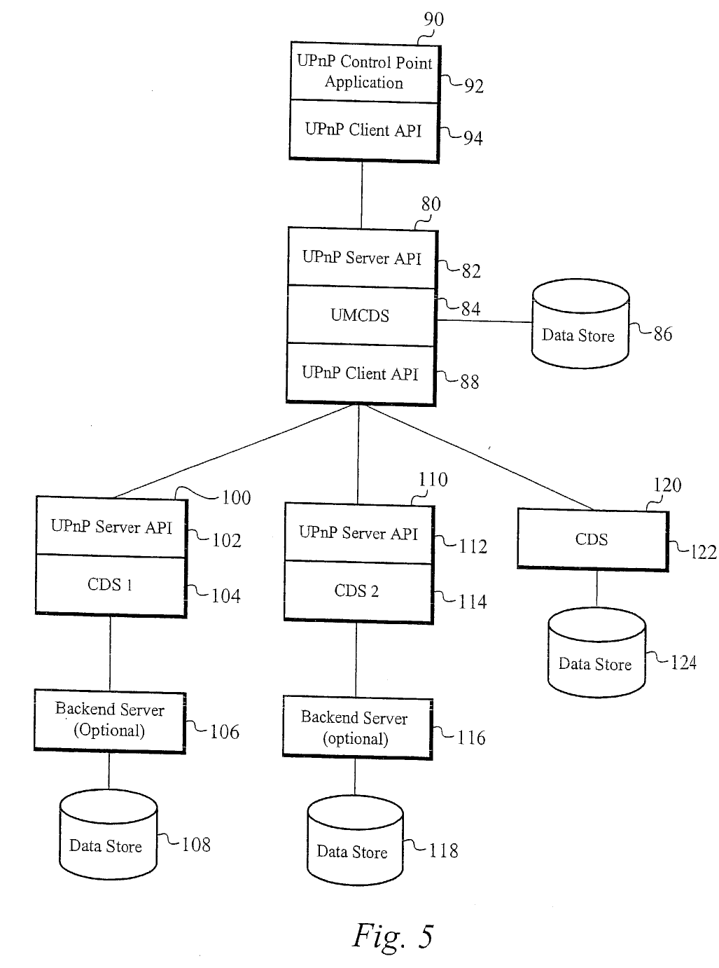

An exemplary UPnP network of devices is illustrated in FIG. 5. The exemplary network of devices of FIG. 5 includes a host device 80 which hosts the consolidated master CDS 84 of the present invention, a control point device 90 and server devices 100, 110 and 120. The control point device 90 includes a control point application 92 and a UPnP client API 94. The server device 100 includes a UPnP server API 102, a CDS 104, a backend server 106 and a data store 108. The server device 110 includes a UPnP server API 112, a CDS 114, a backend server 116 and a data store 118. The server device 120 includes a CDS 122 and a data store 124. The host device 80 includes a UPnP server API 82, a UPnP client API 88, a data store 86 and the master CDS 84.

The host device 80 is preferably a UPnP device with enhanced functionality. The host device 80 includes the UPnP client API 88 which retrieves the content listing information from each CDS of the UPnP server devices 100, 110 and 120. Through the UPnP client API 88, the host device 80 periodically queries the server devices 100, 110 and 120 to obtain the content listings from each CDS 104, 114 and 122, respectively. The content listings are then processed and included within the master CDS 84. The UPnP client API 88 also preferably subscribes to each CDS 104, 114 and 122 in order to obtain notification from the appropriate CDS 104, 114 and 122, when a content listing has been added or removed.

The host device 80 also includes the UPnP server API 82 which allows a control point device 90 to access the master CDS 84. Through the UPnP server API 82, the control point device 90 is able to obtain content listings from the master CDS 84.

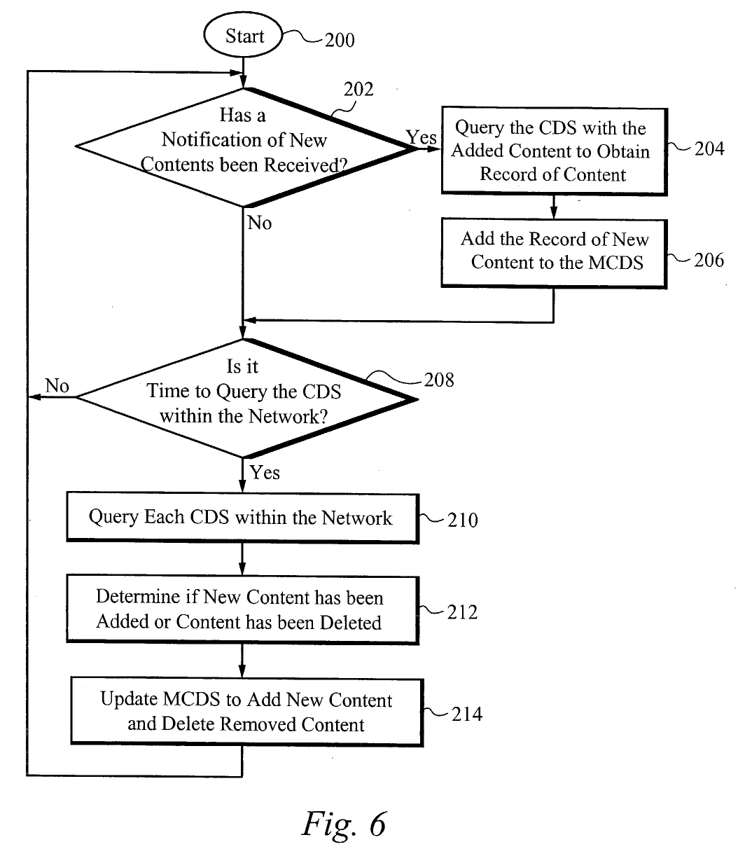

A flowchart of the preferred method of generating, providing and maintaining the consolidated master CDS of the present invention, is illustrated in FIG. 6. The preferred method begins at the step 200. At the step 202, it is determined if a notification of new contents has been received from any CDS to which the client API, managing the master CDS, has subscribed. If it is determined that a notification has been received, then the client API queries the CDS with the added content to obtain the record of the new content, at the step 204. At the step 206, the record of the new content is then added to the master CDS.

After the record of new content has been added to the master CDS at the step 206, or, if it is determined at the step 202 that no notification of new contents has been received, then at the step 208, it is determined if it is time to query every CDS within the network. If it is not yet time to query every CDS within the network, then the process jumps back to the step 202 to determine if a notification of new content has been received. If it is determined at the step 208 that it is time to query every CDS within the network, then at the step 210, each CDS within the network is queried by the client API. At the step 212, the client API then determines from the content listings of each CDS if new content has been added or content has been deleted. At the step 214, the client API then updates the master CDS to accurately reflect any additions of new content and deletions of previously listed content. After the master CDS has been updated, the process then jumps back to the step 202 to determine if a notification of new content has been received.

To provide and maintain the master CDS of the present invention, the client API at the device on which the master CDS is maintained, periodically queries all of the devices with a CDS within the network to obtain a content listing from each CDS. The client API also subscribes to each CDS in order to receive notification when any new content listing is added to a CDS. The client API then combines all of the content listings from each CDS within the network into the master CDS and provides this master CDS to all of the other control point devices within the network. The master CDS is a consolidation of every CDS within the network. When searching for content, the control point devices within the network can then access the master CDS and search listings representing all of the content within the network.

The master CDS preferably only includes listings of the content from every CDS within the network. The actual content is not stored at the device implementing the master CDS, but is still preferably maintained at the original server. When a control point device accesses the master CDS and selects content listed in the master CDS, a communication is then sent to the source device of that content. The content is then transmitted from the original source device to the requesting control point application.

When combining the content listings from every CDS within the network, there may be cases when the same content is listed on multiple CDSs. It is preferable to identify this situation as it occurs and only present one content listing in the master CDS representing the identified content. When an application performs a search or query, it does not want to retrieve several hits with the same name and possibly the same metadata. Transmitting content listings for the same content multiple times increases the bandwidth of the overall system and decreases the efficiency of the master CDS. Therefore, preferably, the master CDS will detect duplicate content entries and pass a single entry to the client application. Criteria such as timestamp and file size are used to determine the actual content listing that will be included within the master CDS. Alternatively, a more sophisticated model that calibrates the actual content against a known benchmark is used to determine the actual content listing that will be included within the master CDS. In an alternate embodiment, multiple content listings for each occurrence of content are included in the master CDS.

Preferably, the master CDS includes metadata information associated with each content listing. This metadata is preferably obtained from the source device including the original content listing.

It is also possible that some of the devices within the network that have a CDS are lightweight devices with limited resources. In this case, the actual content items located on the CDS may be stored in a remote location leaving the CDS only references to content items. In other words, it is possible that the CDS on such a device does not store the actual content item but points to its location by a direct or indirect reference. If this is the case, it is likely that the CDS on such a device will not contain the respective metadata corresponding to the content listings. In such situations, if the client API implementing the master CDS is unable to detect metadata for a content listing it preferably attempts to obtain such metadata information from remote sites, either from within the network or from information available at sites on the internet. Any such metadata information obtained by the master CDS is preferably stored locally by the device implementing the master CDS, associated with the appropriate content listing and made available to control point applications accessing the master CDS. This metadata can be obtained from one site or multiple sites. If parts of the metadata are obtained from multiple sites, this metadata is congregated by the master CDS.

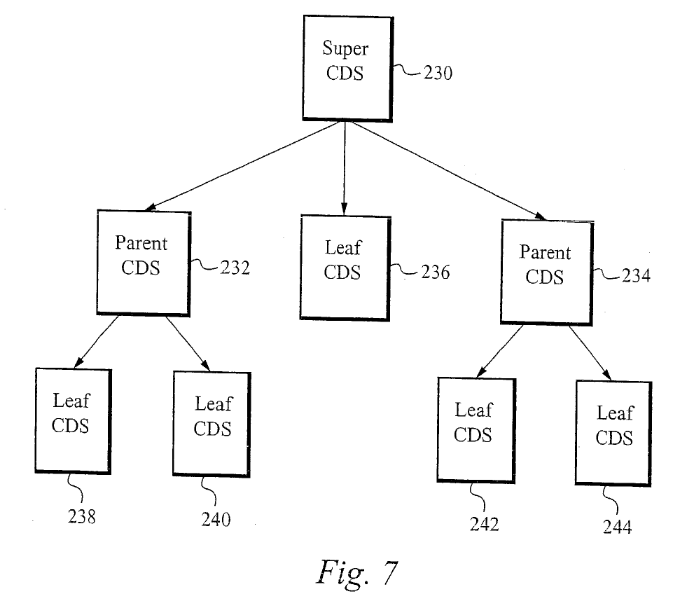

In the preferred embodiment of the present invention, a single master CDS is included within a network which is a consolidated listing of content listings from every CDS within the network. In an alternate embodiment of the present invention, a hierarchical master CDS system is implemented within a network. An example of such a hierarchical master CDS system within an exemplary network is illustrated in FIG. 7. This hierarchical system utilizes the hierarchical system of the network itself. As is well known by those skilled in the art, within a network there are leaf or child nodes and parent nodes. A leaf or child node is coupled to the rest of the network through a parent node. As illustrated in the network of FIG. 7, the child nodes 238 and 240 are coupled to the parent node 232. The child nodes 242 and 244 are coupled to the parent node 234. The parent nodes 232 and 234 are coupled to the parent node 230. In this configuration, the parent nodes 232 and 234 are child nodes to the parent node 230. The child node 236 is also coupled to the parent node 236.

The hierarchical CDS of this embodiment of the present invention, utilizes the hierarchical configuration of the network to provide hierarchical CDSs within the network. Each of the leaf nodes 236, 238, 240, 242 and 244 maintain their own CDS for content listings within their device. Each parent node 230, 232 and 234 maintains a CDS which includes content listings from each of its leaf nodes in addition to its own content listings. The parent CDS 232 includes content listings from each of the leaf CDSs 238 and 240 as well as its own content listings. The parent CDS 234 includes content listings from each of the leaf CDSs 242 and 244 as well as its own content listings. The super CDS 230 includes content listings from each of the parent CDSs 232 and 234 and from the leaf CDS 236, as well as its own content listings. Because of this inherent hierarchy, similar to the master CDS of the preferred embodiment of the present invention, the super CDS 230 includes content listings from each of the nodes within the network. However, in this alternate embodiment, the parent CDSs 232 and 234 provide a middle layer CDS which does not include all of the content listings within the network, but includes content listings from each of their child nodes in addition to their own content listings. In this alternate embodiment, any of the CDSs within the network can be searched for their content listings.

In operation, the master CDS of the present invention provides a consolidated CDS which includes content listings representing all of the content on each device within the network. The master CDS is preferably implemented on a host device and managed by a control point application through that device's client API. This control point application periodically queries each CDS within the network in order to obtain the content listings from each CDS. These obtained content listings are then processed and included within the master CDS. New content listings are added to the master CDS and removed content listings are deleted from the master CDS after the content listings are added to or removed from the respective CDS within the network. The control point application preferably also subscribes to each CDS within the network. With the subscription, when content is added to or removed from the respective CDS within the network, the device implementing that CDS sends notification to the control point application implementing the master CDS. The control point application will then either add or remove a content listing within the master CDS, as appropriate, based on this notification.

Control point applications within the network access the consolidated master CDS to search and obtain content listings from all devices within the network. Preferably, the content itself is stored on the original device and not on the device implementing the master CDS. Thus, the master CDS provides an index of content listings representing content available within the network. Within the master CDS, information is maintained and associated with each content listing regarding the source device for the content listing, preferably providing a data store of pointers to the content, represented by the content listings, throughout the network. When a control point application, accessing the master CDS, selects content for rendering at the device implementing the requesting control point application, a communication is sent to the source device for the selected content, notifying that device that the content has been requested. The transfer parameters are then established for the transmission of the content. The selected content is then transmitted from the source device to the requesting device.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, it will be apparent to one of ordinary skill that while the preferred embodiment of the present invention is implemented on a UPnP network, the master CDS can be implemented on networks utilizing other protocols, including networks utilizing multiple protocols.

We claim:

1. A method of providing a master content directory within a network of devices comprising:
a. querying devices within the network having a content directory service to obtain content listings; and
b. consolidating the content listings from the devices within the network into the master content directory.

2. The method as claimed in claim 1 further comprising providing access to the master content directory to the devices within the network.

3. The method as claimed in claim 2 further comprising receiving a selection of content listed in the master content directory from a requesting device and transmitting selected content from a source device of the selected content to the requesting device.

4. The method as claimed in claim 1 wherein querying devices is performed periodically.

5. The method as claimed in claim 1 further comprising subscribing to receive notification of changes to the content listings from the device.

6. The method as claimed in claim 5 further comprising updating the master content directory in response to a notification of change.

7. The method as claimed in claim 1 wherein consolidating includes detecting duplicate entries and selecting a single entry of a content listing to include within the master content directory.

8. The method as claimed in claim 1 further comprising including metadata information corresponding to the content listings within the master content directory.

9. The method as claimed in claim 8 wherein the metadata information is obtained from a selective one of a source device of the content listing and remote sources of the metadata information.

10. The method as claimed in claim 1 further comprising consolidating the content listings from the devices within the network at multiple devices in a hierarchical fashion, wherein the master content directory is the only consolidated listing of content listings for all devices within the network.

11. The method as claimed in claim 1 wherein the network of devices includes devices that are UPnP enabled.

12. An apparatus for providing a master content directory within a network of devices comprising:
a. an interface to the network of devices;
b. a querying application coupled to the interface to query devices within the network having a content directory service to obtain content listings; and
c. a consolidated master content directory including the content listings from the devices within the network, the consolidated master content directory receiving the content listings obtained by the querying application.

13. The apparatus as claimed in claim 12 wherein the interface provides access to the consolidated master content directory to the devices within the network.

14. The apparatus as claimed in claim 13 wherein if a selection of content listed in the consolidated master content directory is received from a requesting device, then a notification is sent from the interface to a source device of the selected content.

15. The apparatus as claimed in claim 12 wherein the querying application queries the devices within the network having a content directory service periodically.

16. The apparatus as claimed in claim 12 wherein the querying application subscribes to receive notification of changes to the content listings from the devices within the network having a content directory service.

17. The apparatus as claimed in claim 12 wherein the consolidated master content directory selects a single entry of a content listing to include if multiple content listings for the same content are included in the content listings obtained by the querying application.

18. The apparatus as claimed in claim 12 wherein metadata information is included within the consolidated master content directory.

19. The apparatus as claimed in claim 18 wherein the metadata information is obtained from a selective one of a source device of the content listing and remote sources of the metadata information.

20. The apparatus as claimed in claim 12 wherein the network of devices includes devices that are UPnP enabled.

21. An apparatus for providing a master content directory within a network of devices comprising:
a. means for interfacing to the network of devices;
b. means for querying coupled to the means for interfacing for querying devices within the network having a content directory service to obtain content listings; and
c. means for providing a consolidated master content directory coupled to the means for querying for providing content listings from the devices within the network, the consolidated master content directory receiving the content listings obtained by the querying application.

22. The apparatus as claimed in claim 21 wherein the means for interfacing provides access to the consolidated master content directory to the devices within the network.

23. The apparatus as claimed in claim 22 wherein if a selection of content listed in the consolidated master content directory is received from a requesting device, then a notification is sent from the interface to a source device of the selected content.

24. The apparatus as claimed in claim 21 wherein the means for querying queries the devices within the network having a content directory service periodically.

25. The apparatus as claimed in claim 21 wherein the means for querying subscribes to receive notification of changes to the content listings from the devices within the network having a content directory service.

26. The apparatus as claimed in claim 21 wherein the means for providing selects a single entry of a content listing to include if multiple content listings for the same content are included in the content listings obtained by the querying application.

27. The apparatus as claimed in claim 21 wherein the means for providing also provides metadata information corresponding to the content listings within the consolidated master content directory.

28. The apparatus as claimed in claim 27 wherein the metadata information is obtained from a selective one of a source device of the content listing and remote sources of the metadata information.

29. The apparatus as claimed in claim 21 wherein the network of devices includes devices that are UPnP enabled.

30. A host device within a network of devices, the host device comprising:
a. a client application programming interface to communicate with devices within the network of devices;
b. a querying application coupled to the client application programming interface to query devices within the network having a content directory service to obtain content listings; and
c. a consolidated master content directory including the content listings from the devices within the network, the consolidated master content directory receiving the content listings obtained by the querying application.

31. The host device as claimed in claim 30 further comprising a server application programming interface coupled to provide access to the consolidated master content directory to the devices within the network.

32. The host device as claimed in claim 31 wherein if a selection of content listed in the consolidated master content directory is received from a requesting device, then a notification is sent from the server application programming interface to a source device of the selected content.

33. The host device as claimed in claim 30 wherein the querying application queries the devices within the network having a content directory service periodically.

34. The host device as claimed in claim 30 wherein the querying application subscribes to receive notification of changes to the content listings from the devices within the network having a content directory service.

35. The host device as claimed in claim 30 wherein the consolidated master content directory selects a single entry of a content listing to include if multiple content listings for the same content are included in the content listings obtained by the querying application.

36. The host device as claimed in claim 30 wherein metadata information is included within the consolidated master content directory.

37. The host device as claimed in claim 36 wherein the metadata information is obtained from a selective one of a source device of the content listing and remote sources of the metadata information.

38. The host device as claimed in claim 30 wherein the network of devices includes devices that are UPnP enabled.

39. A network of devices comprising:
a. a plurality of content servers each having a content directory service;
b. one or more control point applications; and
c. a host device including:
i. a client application programming interface to communicate with the plurality of content servers;
ii. a querying application coupled to the client application programming interface to query the plurality of content servers to obtain content listings from the content directory services;
iii. a consolidated master content directory including the content listings from the content servers, the consolidated master content directory receiving the content listings obtained by the querying application; and
iv. a server application programming interface coupled to provide access to the consolidated master content directory to the control point applications.

40. The network of devices as claimed in claim 39 wherein if a selection of content listed in the consolidated master content directory is received from a requesting device, then a notification is sent from the server application programming interface to a source device of the selected content.

41. The network of devices as claimed in claim 39 wherein the querying application queries the content servers periodically.

42. The network of devices as claimed in claim 39 wherein the querying application subscribes to receive notification of changes to the content listings from the content servers.

43. The network of devices as claimed in claim 39 wherein the consolidated master content directory selects a single entry of a content listing to include if multiple content listings for the same content are included in the content listings obtained by the querying application.

44. The network of devices as claimed in claim 39 wherein metadata information is included within the consolidated master content directory.

45. The network of devices as claimed in claim 44 wherein the metadata information is obtained from a selective one of a source content server and remote sources of the metadata information.

46. The network of devices as claimed in claim 39 wherein the network of devices includes devices that are UPnP enabled.
